(19) United States
(12) Patent Application Publication
(10) Pub. No.: US 2011/0075260 A1
(43) Pub. Date: Mar. 31, 2011

(54) GRATING DEVICE AND METHOD OF FABRICATING THE SAME

(75) Inventors: Katsumi SHIBAYAMA, Hamamatsu-shi (JP); Masashi ITO, Hamamatsu-shi (JP); Shinichiro AOSHIMA, Hamamatsu-shi (JP)

(73) Assignee: HAMAMATSU PHOTONICS K.K., Hamamatsu-shi (JP)

(21) Appl. No.: 12/568,162

(22) Filed: Sep. 28, 2009

(51) Int. Cl. G02B 5/18; B32B 38/04; B44C 1/22

(52) U.S. Cl. 359/576; 156/250; 216/24

(57) ABSTRACT

In a grating device (1), a plurality of projections (3) that extend in a predetermined direction and projections (4) that extend in a direction substantially perpendicular to the predetermined direction on both sides of the projections (3) in the predetermined direction and that are connected to the end portions of the projections (3) are formed on the surface (2a) of a substrate (2). Thus, since the projections (3) are highly reinforced by the projections (4), it is possible to prevent the projections (3) of a grating portion (6) from being damaged. Moreover, since the surface (5a) of a substrate (5) is joined to the top portions (3a) and (4a) of the projections (3) and (4), it is possible to prevent the intrusion of particles into the area between the projections (3). Furthermore, since the projections (3) are formed integrally with the substrate (2) and the top portions (3a) of the projections (3) are joined to the surface (5a) of the substrate (5) by direct bonding, it is possible to reduce light loss in the grating portion (6) including the projections (3) and the substrates (2) and (5).

### BACKGROUND OP THE INVENTION

1. Field of the Invention

The present invention relates to a grating device provided with a grating portion that diffracts light and a method of fabricating the grating device.

2. Related Background Art

Conventionally, as a method of fabricating a grating device, there is known a method of forming, when a plurality of projections extending in a predetermined direction are formed on the surface of a substrate, the projections integrally with the substrate by nanoimprinting and etching (for example, see JP-A-2005-313278).

### SUMMARY OF THE INVENTION

However, the formation of the projections integrally with the substrate by nanoimprinting and etching allows a fine pattern to be efficiently formed, but may cause the reliability of the grating device to be degraded as a result of damage to the projections, the intrusion of particles into the area between the projections or other problems.

In view of the foregoing, the object of the present invention is to provide a highly reliable grating device and a method of fabricating such a grating device.

To achieve the above object, according to one aspect of the present invention, there is provided a grating device including a grating portion that diffracts light, the grating device including: a first substrate; a plurality of first projections that extend in a predetermined direction and are provided on a surface of the first substrate so as to be arranged side by side in a direction substantially perpendicular to the predetermined direction; a second projection that extends in a direction intersecting the predetermined direction and is provided on the surface of the first substrate so as to be approximately equal in height to one of the first projections; and a second substrate having a surface joined to top portions of the first and second projections by direct bonding, in which the grating portion includes the first projections and the first and second substrates.

In this grating device, a plurality of first projections that extend in a predetermined direction and a second projection that extends in a direction intersecting the predetermined direction are provided. Thus, since the first projections are reinforced by the second projection, it is possible to prevent the first projections of a grating portion from being damaged. Moreover, since the surface of the second substrate is joined to the top portions of the first and second projections, it is possible to prevent the intrusion of particles into the area between the first projections. Furthermore, since the top portions of the first projections are joined to the surface of the second substrate by direct bonding, it is possible to reduce light loss in the grating portion including the first projections and the first and second substrates. Therefore, with this grating device, it is possible to maintain high reliability.

In the grating device of the present invention, the first projections are preferably formed integrally with the first substrate. In this case, it is possible not only to efficiently form the first projections on the first substrate but also to further reduce light loss in the grating portion.

In the grating device of the present invention, the second projection is preferably provided on the surface of the first substrate so as to extend in the direction intersecting the predetermined direction on both sides of the first projections in the predetermined direction and so as to be connected to end portions of the first projections. In this case, since the first projections are greatly reinforced by the second projection, it is possible to more reliably prevent the first projections from being damaged.

According to another aspect of the present invention, there is provided a method of fabricating a grating device including grating portions that diffract light, the method including the steps of; preparing a first wafer and a second wafer, the first wafer including a plurality of first substrates having a surface on which a plurality of first projections extend in a predetermined direction and are provided so as to be arranged side by side in a direction substantially perpendicular to the predetermined direction and on which a second projection extends in a direction intersecting the predetermined direction and is provided so as to be approximately equal in height to one of the first projections, the second wafer including a plurality of second substrates arranged so as to correspond to the first substrates; performing activation treatment on top portions of the first projections and the second projection on the first wafer and surfaces of the second substrates in the second wafer; joining, after completion of the activation treatment, the top portions of the first projections and the second projection to the surfaces of the second substrates by direct bonding, and forming a plurality of grating portions including the first projections, the first and second substrates, and cutting, after completion of the formation of the grating portions, the first and second wafers in sets of the corresponding first and second substrates.

In this method of fabricating a grating device, the first wafer including a plurality of first substrates and the second wafer including a plurality of second substrates arranged so as to correspond to the first substrates are used, a highly reliable grating device can be produced extremely efficiently.

Preferably, in the method of fabricating a grating device according to the present invention, in the step of preparing the first and the second wafers, the first projections are formed integrally with the first substrates by nanoimprinting and etching, and thus the first projections are formed on the surfaces of the first substrates. By adopting the nanoimprinting and etching, it is possible to efficiently form the first projections of a fine pattern.

### BRIEF DESCRIPTION OF THE DRAWINGS

FIG. 1 is a plan view of an embodiment of a grating device according to the present invention;

FIG. 2 is a cross-sectional view taken along line II-II of FIG. 1;

FIG. 3 is a cross-sectional view taken along line of FIG. 1;

FIGS. 4A and 4B are diagrams showing nanoimprinting and etching processes for fabricating the grating device shown in FIG. 1;

FIGS. 5A and 5B are diagrams showing the nanoimprinting and etching processes for fabricating the grating device shown in FIG. 1;

FIG. 6 is a diagram showing the nanoimprinting and etching processes for fabricating the grating device shown in FIG. 1;

FIGS. 7A and 7B are diagrams showing the nanoimprinting and etching processes for fabricating the grating device shown in FIG. 1;

FIGS. 8A and 8B are diagrams showing the nanoimprinting and etching processes for fabricating the grating device shown in FIG. 1;

FIG. 9 is a diagram showing the nanoimprinting and etching processes for fabricating the grating device shown in FIG. 1;

FIG. 10 is a plan view of a wafer that has been subjected to the nanoimprinting and etching processes shown in FIGS. 4 to 9;

FIG. 11 is a diagram showing an activation treatment and a direct bonding process for fabricating the grating device shown in FIG. 1;

FIG. 12 is a diagram showing the activation treatment and the direct bonding process for fabricating the grating device shown in FIG. 1;

FIG. 13 is a diagram showing the activation treatment and the direct bonding process for fabricating the grating device shown in FIG. 1;

FIG. 14 is a plan view of a wafer that has been subjected to the activation treatment and the direct bonding process shown in FIGS. 11 to 13;

FIGS. 15A, 15B and 15C are plan views of another embodiment of the grating device according to the present invention; and

FIGS. 16A and 16B are plan views of another embodiment of the grating device according to the present invention.

### DESCRIPTION OF THE PREFERRED EMBODIMENTS

Preferred embodiments of the present invention will be described in detail below with reference to the accompanying drawings. In the drawings, like parts or corresponding parts are represented by like reference numerals, and overlapping description will be omitted.

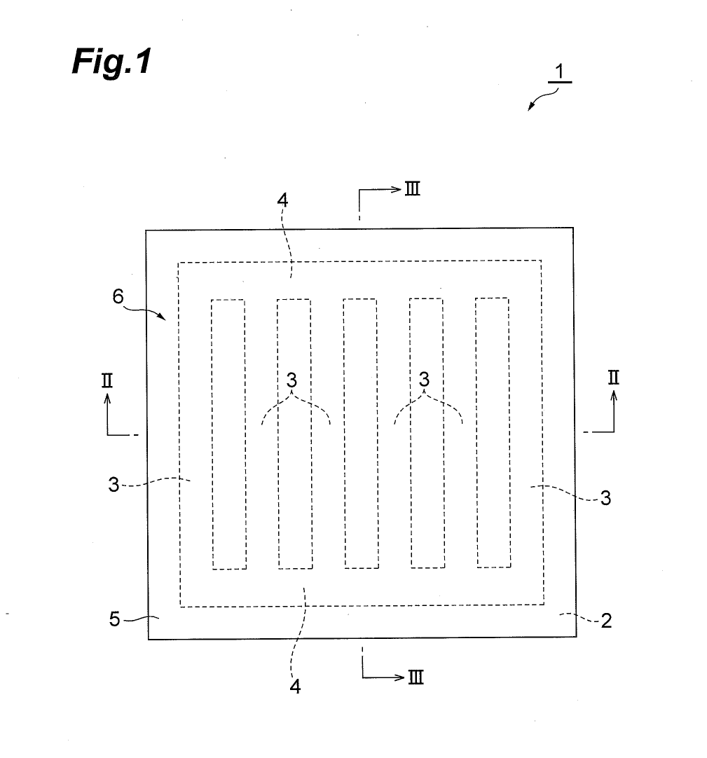

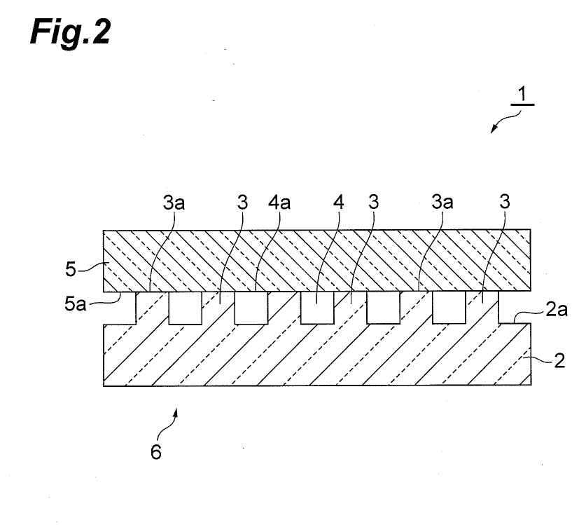

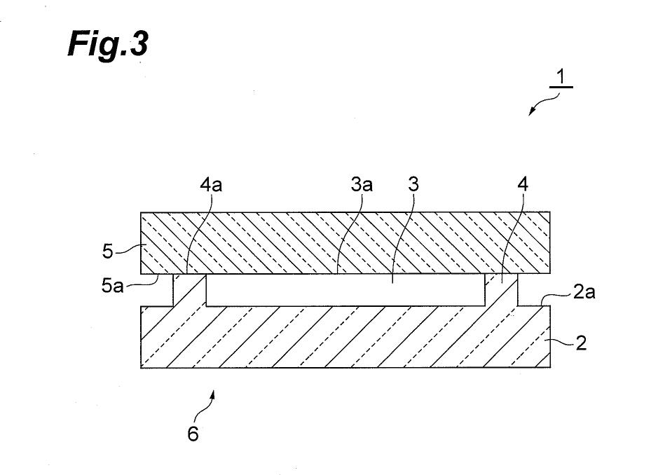

FIG. 1 is a plan view of an embodiment of a grating device according to the present invention. FIG. 2 is a cross-sectional view taken along line of FIG. 1; FIG. 3 is a cross-sectional view taken along line III-III of FIG. 1. As shown in FIGS. 1 to 3, the grating device 1 is provided with a rectangular plate-shaped substrate (a first substrate) 2 formed of quartz.

On the surface 2a of the substrate 2, there is provided a plurality of projections (first projections) 3 that extend in a predetermined direction and that are arranged side by side in a direction substantially perpendicular to the predetermined direction. The cross section of the projection 3 along the direction substantially perpendicular to the predetermined direction is rectangular with a width of 250 nm and a height of 1000 nm. The projections 3 are formed integrally with the substrate 2 and with 500 nm pitches (that is, a duty ratio of 0.5).

Moreover, on the surface 2a of the substrate 2, there is provided projections (second projections) 4 that extend in the direction substantially perpendicular to the predetermined direction on both sides of the projections 3 in the predetermined direction and that are approximately equal in height to the projections 3. The cross section of the projection 4 along the predetermined direction is rectangular with a width of 250 nm and a height of 1000 nm; the projections 4 are formed integrally with the substrate 2 such that they are connected to the end portions of the projections 3 in the predetermined direction.

A rectangular plate-shaped substrate (a second substrate) 5 formed of quartz is joined to the projections 3 and 4. The surface 5a of the substrate 5 is joined to the top portions 3a of the projections 3 and the top portions 4a of the projections 4 by direct bonding. In the grating device 1, a grating portion 6 is formed with the projections 3 and the substrates 2 and 5. The grating portion 6 is a transmission grating that diffracts light.

In the grating device 1 configured as described above, a plurality of projections 3 that extend in the predetermined direction and the projections 4 that extend in the direction substantially perpendicular to the predetermined direction on both sides of the projections 3 in the predetermined direction and that are connected to the end portions of the projections 3 are formed on the surface 2a of the substrate 2. Thus, since the projections 3 are highly reinforced by the projections 4, it is possible to prevent the projections 3 of the grating portion 6 from being damaged. Moreover, since the surface 5a of the substrate 5 is joined to the top portions 3a and 4a of the projections 3 and 4, it is possible to prevent the intrusion of particles into the area between the projections 3. Furthermore, since the projections 3 are formed integrally with the substrate 2 and the top portions 3a of the projections 3 are joined to the surface 5a of the substrate 5 by direct bonding, it is possible to reduce light loss in the grating portion 6 including the projections 3 and the substrates 2 and 5. Therefore; with the grating device 1, it is possible to maintain high reliability.

A method of fabricating the above-described grating device 1 will now be described. The grating device 1 is fabricated by sequentially undergoing nanoimprinting and etching processes, an activation treatment, a direct bonding process and a dicing process.

### [Nanoimprinting and Etching Processes]

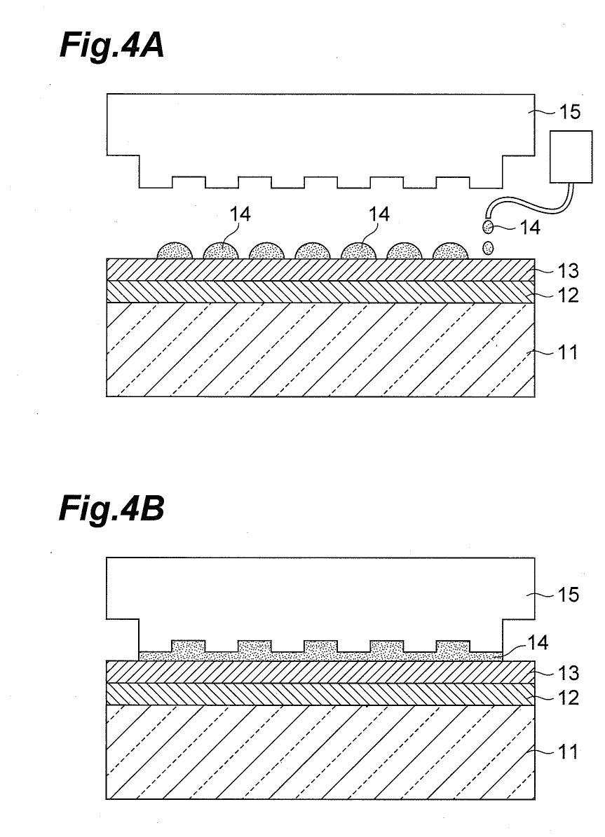

As shown in FIG. 4A, a wafer (a first wafer) 11 that is formed of quartz and that has a diameter of 6 inches and a thickness of 625 μm is prepared as an imprint substrate in which a 0.1 to 0.5 μm thick WSi layer 12 is formed by sputtering on its surface and in which a 50 to 2000 nm thick close contact layer 13 is formed, as a resist layer, on the surface of the WSi layer 12 by application. Then, an imprint resin 14 is applied to the surface of the close contact layer 13. Then, as shown in FIG. 4B, a master mold 15 is pressed on the close contact layer 13 to expand the imprint resin 14.

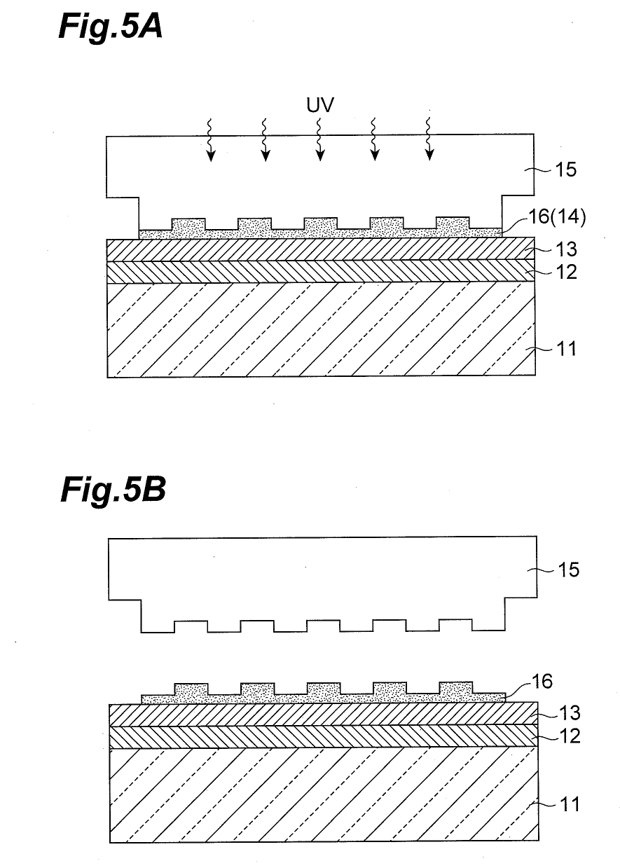

With the master mold 15 being pressed on the close contact layer 13, as shown in FIG. 5A, ultraviolet light is applied to the imprint resin 14 through the master mold 15, and thus the imprint resin 14 is UV-cured to form an imprint resin layer 16. Then, as shown in FIG. 5B, the master mold 15 is removed from the imprint resin layer 16. The application of the imprint resin 14, the pressing of the master mold 15, the application of ultraviolet light on the imprint resin 14 and the removal of the master mold 15 described above are performed in each of a plurality of preset regions arranged in a matrix on the wafer 11 so as to correspond to the substrate 2 of the grating device 1.

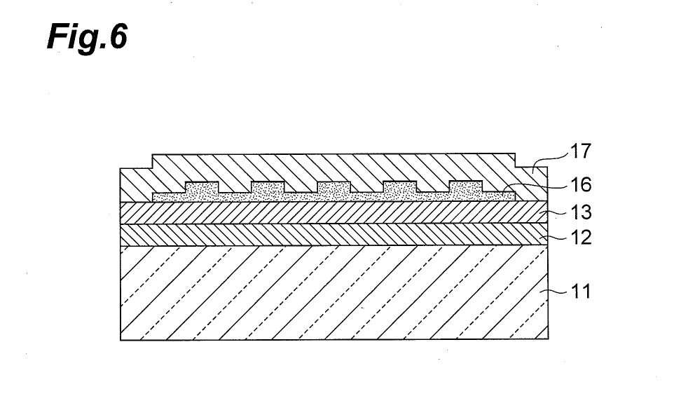

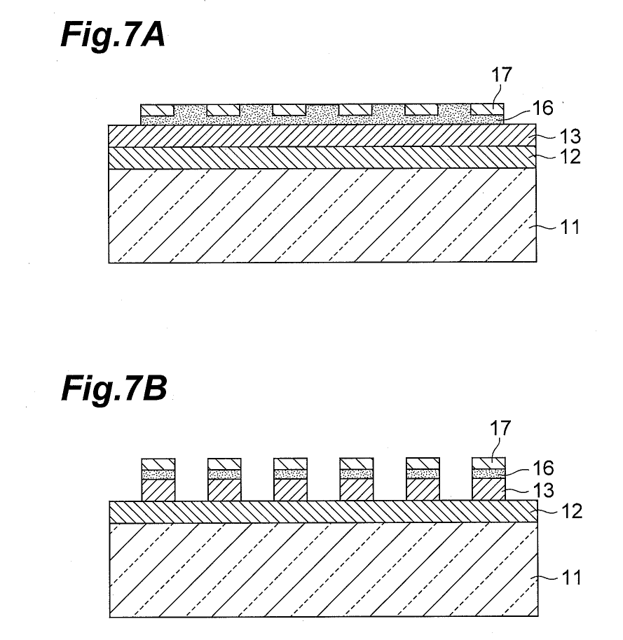

The imprint resin layer 16 is formed on the surface of the close contact layer 13, and then, as shown in FIG. 6, a Si-containing resin layer 17 is formed so as to cover the imprint resin layer 16 by application. Thereafter, as shown in FIG. 7A, the Si-containing resin layer 17 is removed by dry etching using halogen gas, and the top portions of the imprint resin layer 16 are exposed from the Si-containing resin layer 17. Then, as shown in FIG. 7B, the remaining Si-containing resin layer 17 is used as a mask, and thus the exposed portions of the imprint resin layer 16 and the close contact layer 13 are removed by dry etching using O₂ gas.

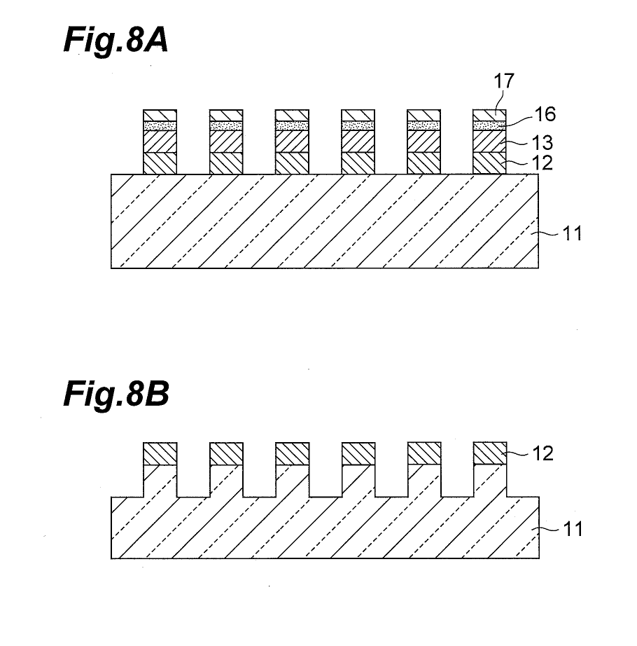

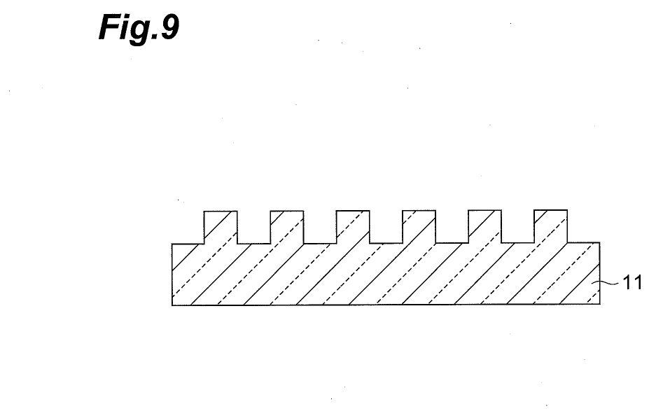

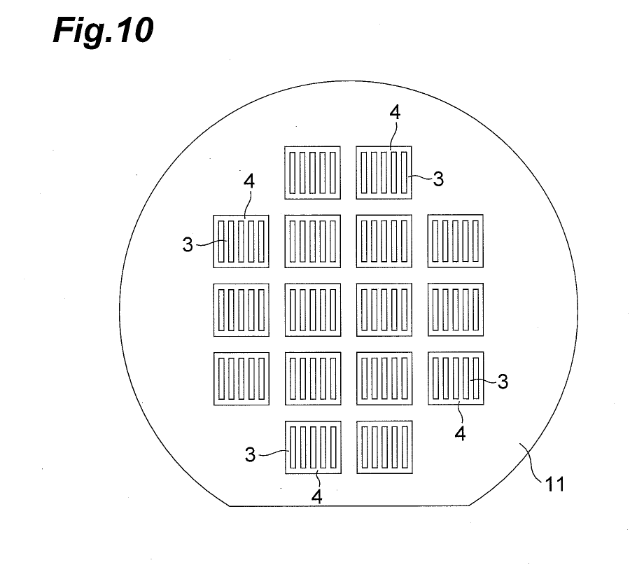

As shown in FIG. 8A, the remaining Si-containing resin layer 17 is used as a mask, and thus the exposed portions of the WSi layer 12 are removed by dry etching using SF₆ gas. Then, as shown in FIG. 8B, parts of the exposed portions of the Si-containing resin layer 17, the imprint resin layer 16, the close contact layer 13 and the wafer 11 are removed by dry etching using CHF₃ gas. Then, as shown in FIG. 9, the WSi layer 12 is removed. In this way, as shown in FIG. 10, projections 3 and 4 are formed in each of a plurality of preset regions arranged in a matrix on the wafer 11 so as to correspond to the substrate 2 of the grating device 1. Although, in this case, WSi is used as the material of the layer serving as the etching mask of the wafer 11, metal such as Cr, amorphous silicon, ceramic, resin or the like may be used as long as it has a high etching selectivity with quartz.

When the nanoimprinting and etching are adopted in this way, the projections 3 of a fine pattern formed on the order of submicrons or less can be effectively formed integrally with the substrate 2, with the result that mass production can be achieved. Since this process is not affected by parameters (kl, NA) on resolution as compared with optical lithography, the projections 3 of a finer pattern can be formed.

### [Activation Treatment and Direct Bonding Process]

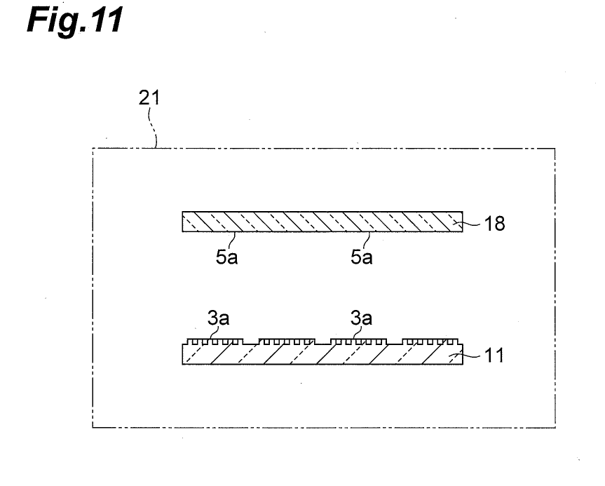

As shown in FIG. 11, the wafer 11 that has been subjected to the nanoimprinting and etching processes is arranged opposite a wafer (second wafer) 18 formed of quartz within a vacuum chamber 21. The wafer 11 includes a plurality of substrates 2 having the surface 2a on which the projections 3 and 4 are provided. The wafer 18 includes the substrate 5 of the grating device 1 that is arranged so as to correspond to the substrates 2 included in the wafer 11.

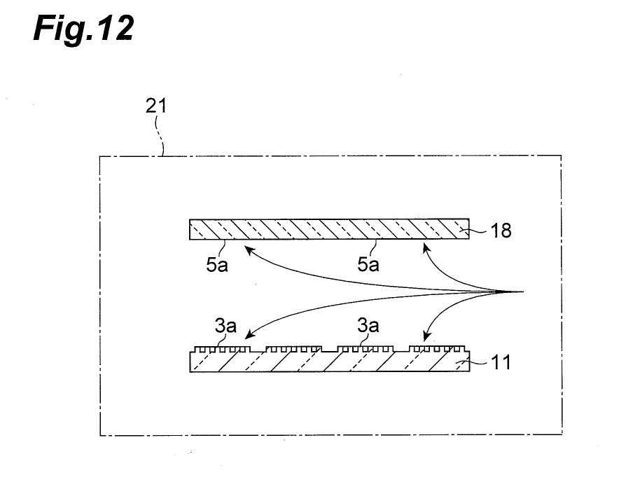

Thereafter, as shown in FIG. 12, ions of inert gas such as Ar or beams of neutral atoms are irradiated in a vacuum, and thus activation treatment is performed on at least the top portions 3a and 4a of the projections 3 and 4 of the wafer 11 and the surface 5a of the substrate 5 of the wafer 18. In this way, an oxidized film and an absorption layer present on the top portions 3a and 4a of the projections 3 and 4 and the surface 5a of the substrate 5 are removed, with the result that atoms of quartz have dangling bonds extended.

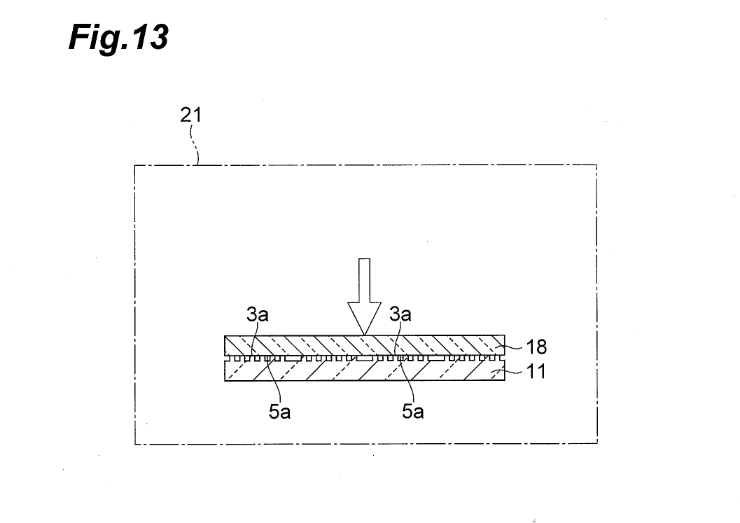

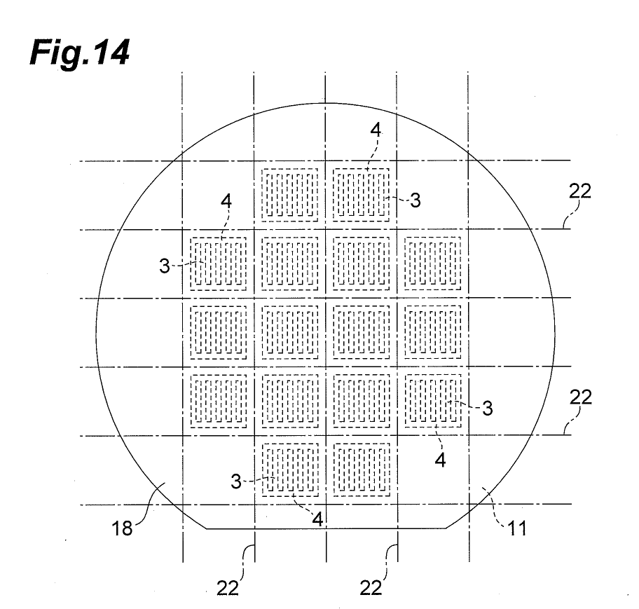

Thereafter, as shown in FIG. 13, the activated top portions 3a and 4a of the projections 3 and 4 and the activated surface 5a of the substrate 5 come in contact with each other, and pressure is applied at room temperature to join the top portions 3a and 4a of the projections 3 and 4 to the surface 5a of the substrate 5 by direct bonding. Thus, as shown in FIG. 14, the grating portions 6 including the projections 3 and the substrates 2 and 5 are formed in each of a plurality of preset regions arranged in a matrix on the wafers 11 and 18 so as to correspond to the substrates 2 and 5 of the grating device 1.

When the activation treatment and the direct bonding are adopted in this way, it is possible to perform the joining at room temperature, with the result that the wafers 11 and 18 can be prevented from being thermally distorted and the satisfactory flatness necessary for the top portions 3a and 4a of the projections 3 and 4 and the surface 5a of the substrate 5 can be acquired. Moreover, since a different type of intermediate layer such as adhesive is not included between the top portions 3a and 4a of the projections 3 and 4 and the surface 5a of the substrate 5, it is possible to acquire satisfactory optical characteristics in the grating portion 6. Furthermore, since the wafers 11 and 18 are formed of the same type of material, it is possible to reduce reflection on the junction interface between the top portions 3a and 4a of the projections 3 and 4 and the surface 5a of the substrate 5; this makes it possible to obtain a satisfactory diffraction efficiency in the grating portion 6.

### [Dicing Process]

As shown in FIG. 14, cutting lines 22 are set for each of the grating portions 6 arranged in a matrix (that is, for each of the corresponding substrates 2 and 5) on the wafers 11 and 18 that have been subjected to the activation treatment and the direct bonding, and the wafers 11 and 18 are cut along the cutting lines 22 with a blade or the like, with the result that a plurality of grating devices 1 are obtained.

Here, the projections 4 that extend in the direction substantially perpendicular to the predetermined direction are connected to both ends of the projections 3 that extend in the predetermined direction, and the projections 3 are reinforced by a beam structure that is formed by the projections 4. Thus, it is possible to prevent the projections 3 from being damaged due to stress produced by the dicing. Moreover, since the projections 3 and 4 are sandwiched between the substrates 2 and 5, it is possible to prevent the intrusion of particles into the area between the projections 3.

As described above, in the method of fabricating the grating device 1, since the wafer 11 including a plurality of substrates 2 and the wafer 18 including a plurality of substrates 5 arranged so as to correspond to the substrates 2 are used, a highly reliable grating device 1 can be produced extremely efficiently and its mass production can be achieved.

In the above-described fabrication method, the direct bonding can be satisfactorily achieved because the top portions 3a and 4a of the projections 3 and 4 are joined to the surface 5a of the substrate 5. Since the direct bonding is bonding that is performed at the atomic level, the flatness and the accuracy of the bonded surfaces are required to be sufficiently high. Thus, when the bonded surfaces are larger than necessary, it is likely that fine particles intervene between the bonded surfaces and this results in a bonding failure. Moreover, when the bonded surfaces are larger than necessary, it is difficult to acquire the sufficient flatness and accuracy, and this may also result in a bonding failure. The occurrence of such a bonding failure causes voids between the bonded surfaces, and this results in the defective grating device 1. To overcome this problem, the grating device 1 adopts a structure in which the bonding is performed on only the minimum necessary parts such as the top portions 3a and 4a of the projections 3 and 4. By removing unnecessary parts through etching, it is possible to prevent particles between the bonded surfaces and the occurrence of voids.

The present invention is not limited to the embodiment described above.

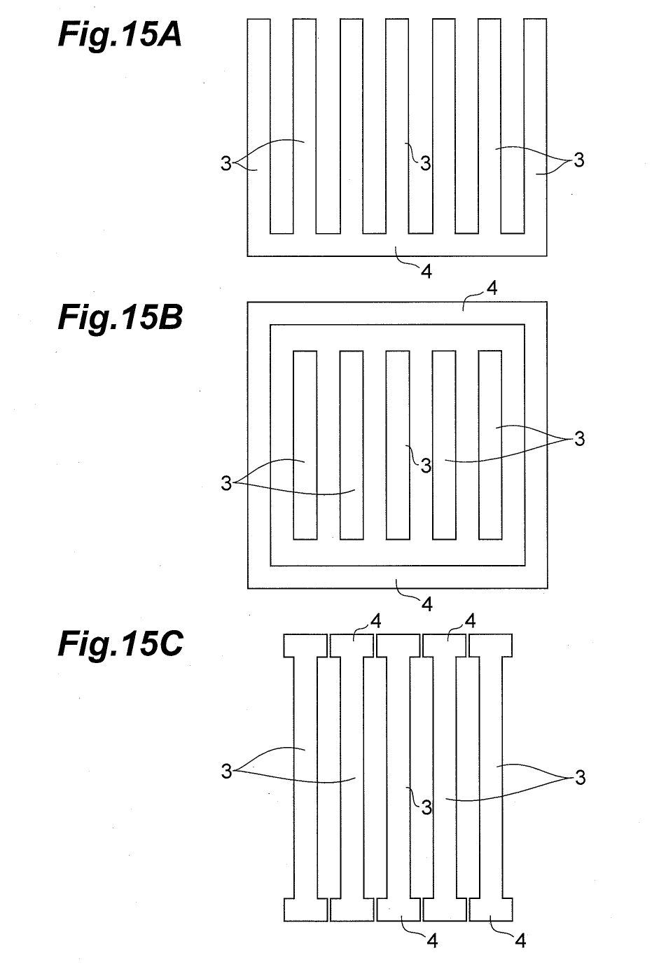

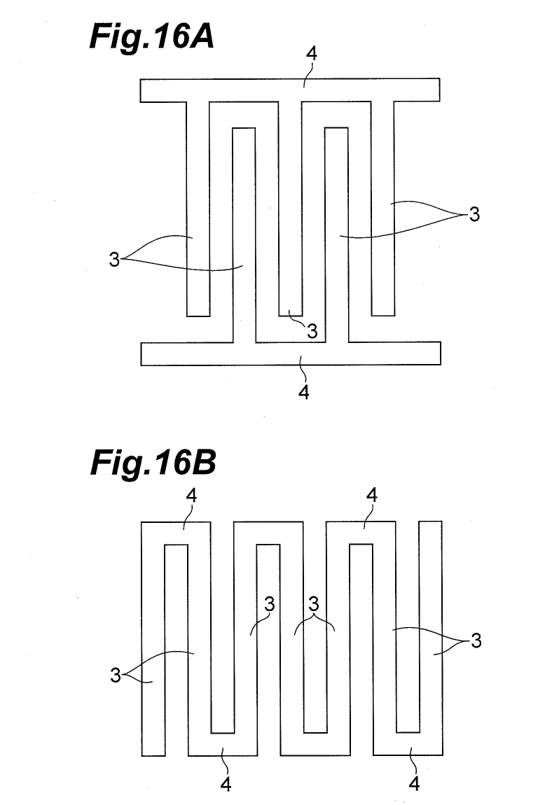

For example, as shown in FIG. 15A, the projections 4 may be provided on only one side of the projections 3 extending in the predetermined direction. Moreover, as shown in FIG. 15B, the projections 4 may be designed so that they are not connected to the end portions of the projections 3 extending in the predetermined direction; as shown in FIG. 15C, a plurality of the projections 4 may be provided for each end portion of the projections 3 extending in the predetermined direction. Moreover, as shown in FIG. 16A, the projection 4 may be alternately connected to the end portions of the projections 3 extending in the predetermined direction; as shown in FIG. 16B, the projections 4 may be connected to the end portions of the projections 3 such that the projections 3 and 4 are shaped in a zigzag pattern. The projections 4 may intersect the projections 3. In order to maintain the ease of fabrication and the aperture ratio of the grating portion 6, it is preferable that the projections 4 be provided on the end portions of the projections 3.

Although the above embodiment deals with the case where the projections 3 and 4 and the substrates 2 and 5 are formed of the same materials, the projections 3 and 4 and the substrates 2 and 5 may be formed of respective different materials. Moreover, although the above embodiment deals with the case where the substrates 2 and 5 are individually formed of one layer, the substrates 2 and 5 may be individually formed of a plurality of layers. In an example, the substrate 5 may have the main layer formed of quartz and either an AR film (anti-reflective film) formed of SiO₂ and the like on the surface 5a or AR films formed on both the surface 5a and the surface opposite to the surface 5a. In this case, it is also possible to join the top portions 3a and 4a of the projections 3 and 4 to the surface 5a of the substrate 5 by direct bonding.

Although the above embodiment deals with the case where the grating portion 6 is a transmission grating, the grating portion 6 may be formed as a reflection grating in which the substrate 5 has reflective films on the surface 5a and the surface opposite to the surface 5a or the substrate 2 has reflective films on the surface 2a and the surface opposite to the surface 2a.

Although the above embodiment discusses, as a nanoimprinting process, the UV imprint process using the UV-cured resist, a thermal imprint process using a thermally deformable resist may be adopted.

According to the present invention, the reliability of the grating device can be enhanced.

What is claimed is:

1. A grating device including a grating portion that diffracts light, the grating device comprising:
a first substrate;
a plurality of first projections that extend in a predetermined direction and are provided on a surface of the first substrate so as to be arranged side by side in a direction substantially perpendicular to the predetermined direction;
a second projection that extends in a direction intersecting the predetermined direction and is provided on the surface of the first substrate so as to be approximately equal in height to one of the first projections; and
a second substrate having a surface joined to top portions of the first and second projections by direct bonding,
wherein the grating portion includes the first projections and the first and second substrates.

2. The grating device of claim 1,
wherein the first projections are formed integrally with the first substrate.

3. The grating device of claim 1,
wherein the second projection is provided on the surface of the first substrate so as to extend in the direction intersecting the predetermined direction on both sides of the first projections in the predetermined direction and so as to be connected to end portions of the first projections.

4. A method of fabricating a grating device including grating portions that diffract light, the method comprising the steps of;
preparing a first wafer and a second wafer, the first wafer including a plurality of first substrates having a surface on which a plurality of first projections extend in a predetermined direction and are provided so as to be arranged side by side in a direction substantially perpendicular to the predetermined direction and on which a second projection extends in a direction intersecting the predetermined direction and is provided so as to be approximately equal in height to one of the first projections, the second wafer including a plurality of second substrates arranged so as to correspond to the first substrates;
performing activation treatment on top portions of the first projections and the second projection on the first wafer and surfaces of the second substrates in the second wafer;
joining, after completion of the activation treatment, the top portions of the first projections and the second projection to the surfaces of the second substrates by direct bonding, and forming a plurality of grating portions including the first projections, the first and second substrates, and
cutting, after completion of the formation of the grating portions, the first and second wafers in sets of the corresponding first and second substrates.

5. The method of fabricating a grating device, according to claim 4,
wherein, in the step of preparing the first and the second wafers, the first projections are formed integrally with the first substrates by nanoimprinting and etching, and thus the first projections are formed on the surfaces of the first substrates.
